(19) United States
(12) Patent Application Publication
(10) Pub. No.: US 2021/0173214 A1
(43) Pub. Date: Jun. 10, 2021

(54) PROJECTION APPARATUS AND WEARABLE DISPLAY DEVICE

(71) Applicant: Coretronic Corporation, Hsin-Chu (TW)

(72) Inventors: CHIH-WEI SHIH, Hsin-Chu (TW); MENG-HSUAN LIN, Hsin-Chu (TW)

(21) Appl. No.: 17/110,341

(22) Filed: Dec. 3, 2020

(30) Foreign Application Priority Data
Dec. 5, 2019 (CN) 201911232752.X

(51) Int. Cl. G02B 27/01; G03B 21/20

(52) U.S. Cl. CPC G02B 27/0172; G03B 21/2033; G03B 21/2066; G03B 21/208

(57) ABSTRACT

A projection apparatus includes an illumination component, a light valve and an imaging component. The illumination component includes a light source module, a diffuser and a prism module. The light source module provides an illumination beam, and the light source module has a light emitting side. The diffuser is disposed between the light source module and the prism module. The illumination beam passes through the diffuser to the prism module. The light valve has an active surface for converting the illumination beam into an image beam. The illumination beam passing through the diffuser is transmitted to the light valve through the prism module. The imaging component receives and projects the image beam. The projection apparatus has the advantage of effectively eliminating structured light. A wearable display device using the projection apparatus is also provided.

### CROSS-REFERENCE TO RELATED APPLICATION

This application claims the priority benefit of China application (CN201911232752.X), filed on Dec. 5, 2019. The entirety of the above-mentioned patent application is hereby incorporated by reference herein and made a part of this specification.

### FIELD OF THE INVENTION

The invention relates to a display device, and more particularly to a projection apparatus and a wearable display device.

### BACKGROUND OF THE INVENTION

A head-mounted display (HMD) uses an optical projection system to project images and/or text messages on a display element into a user's eyes. With the development of micro displays in higher resolution, smaller size and lower power consumption and the development of cloud technology in which large amounts of information can be downloaded from the cloud at any time, the head-mounted display devices is developed as a wearable display device. In addition to the military field, the wearable display devices also grow and occupy an important position in other related fields such as industrial production, simulation training, 3D display, medical treatment, sports and video games.

In the mini-optical engine of the augmented reality (AR) device or the virtual reality (VR) device, due to the limitations of the body machine, the extension region of many mechanisms and even the optically effective region are sacrificed to obtain a thinner and lighter design. However, because of this, unexpected stray and structured light is generated, and therefore the quality of the image output is affected.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a projection apparatus and a wearable display device, which can effectively eliminate the structured light generated by the projection apparatus due to volume limitation.

Other advantages and objects of the invention can be further understood from the technical features disclosed by the invention.

In order to achieve one or a portion of or all of the objects or other objects, the projection apparatus provided by the invention includes an illumination component, a light valve and an imaging component. The illumination component includes a light source module, a diffuser and a prism module. The light source module provides an illumination beam, and the light source module has a light emitting side. The diffuser is disposed between the light source module and the prism module. The illumination beam passes through the diffuser to the prism module. The light valve has an active surface for converting the illumination beam into an image beam. The illumination beam passing through the diffuser is transmitted to the light valve by the prism module. The imaging component receives and projects the image beam.

In order to achieve one or a portion of or all of the objects or other objects, the wearable display device provided by the invention includes a projection apparatus and a waveguide element. The projection apparatus includes an illumination component, a light valve and an imaging component. The illumination component includes a light source module, a diffuser and a prism module. The light source module provides an illumination beam. The light source module has a light emitting side. The diffuser is disposed between the light source module and the prism module. The illumination beam passes through the diffuser to the prism module. The light valve has an active surface for converting the illumination beam into an image beam. The illumination beam passing through the diffuser is transmitted to the light valve by the prism module. The imaging component receives and projects the image beam. The waveguide element guides the image beam and projects the image beam to a projection target.

In the invention, the configuration in which the diffuser is disposed between the light source module and the prism module can eliminate the structured light caused by volume limitation of the projection apparatus, that is, reduce the distribution of uneven light. Further, the use of a diffuser with an opening or a top-hat type diffuser can effectively improve the geometric efficiency caused by a general diffuser.

Other objectives, features and advantages of The invention will be further understood from the further technological features disclosed by the embodiments of The invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection apparatus according to an embodiment of the invention;

FIG. 2 is a schematic structural view of a light uniform module according to an embodiment of the invention;

FIGS. 3a to 3i are respective schematic views of light spot images on a light valve when sub-illumination beams outputted by a micro lenses in different rows are directly transmitted to the light valve by a prism module;

FIG. 4a is a schematic view of a superimposed light spot on a light valve;

FIG. 4b is a schematic view of a superimposed light spot on a light valve according to an embodiment of the invention;

FIG. 5 is a schematic view of an arrangement in which a diffuser is disposed corresponding to a micro-lens array according to an embodiment of the invention;

FIG. 6 is a schematic view of an arrangement in which a diffuser is disposed corresponding to a micro-lens array according to another embodiment of the invention;

FIGS. 7a and 7b are schematic views of the diffusion angle and light intensity of a Gaussian type diffuser and a top-hat type diffuser, respectively;

FIGS. 8a and 8b are schematic views of the light spot on the light valve formed by a Gaussian type diffuser and a top-hat type diffuser, respectively;

FIG. 9 is a schematic view of a projection apparatus according to another embodiment of the invention;

FIG. 10 is a schematic view of a wearable display device according to an embodiment of the invention; and

FIG. 11 is a schematic application view of a wearable display device according to an embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

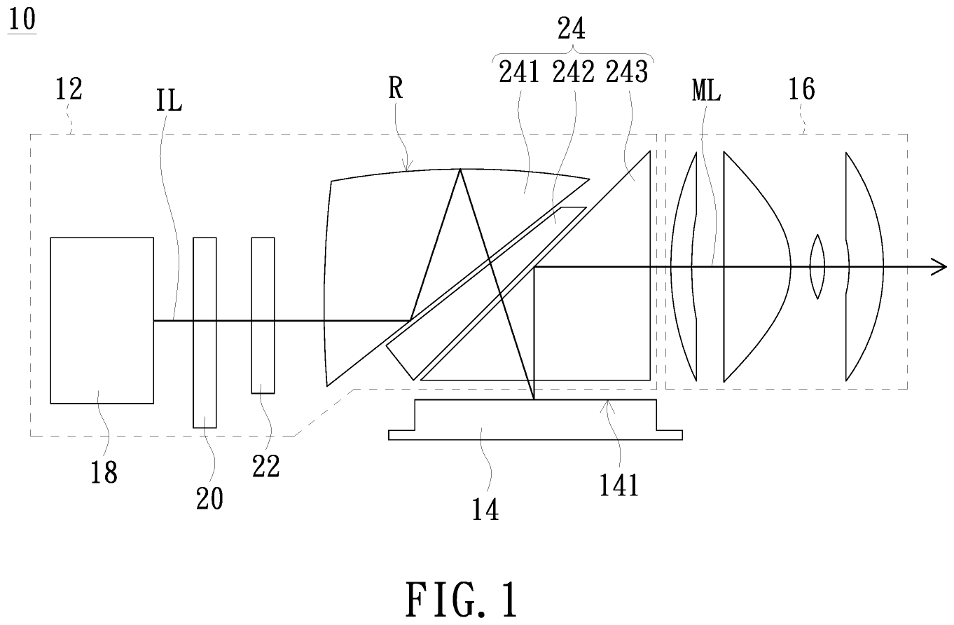

FIG. 1 is a schematic view of a projection apparatus according to an embodiment of the invention. As shown in FIG. 1, the projection apparatus 10 includes an illumination component 12, a light valve 14 and an imaging component 16. The illumination component 12 is used to provide an illumination beam IL to the light valve 14. The illumination component 12 includes a light source module 18, a light uniform module 20, a diffuser 22 and a prism module 24. The light source module 18 provides the illumination beam IL. The illumination beam IL is transmitted to the light valve 14 through the light uniform module 20, the diffuser 22 and the prism module 24. In the embodiment, the light source module 18 is, for example, a laser diode light source module or a light emitting diode light source module. The light source module 18 has a light emitting side. The light uniform module 20 is disposed on the light emitting side of the light source module 18. The diffuser 22 is disposed between the light uniform module 20 and the prism module 24. The illumination beam IL passes through the light uniform module 20, the diffuser 22 and the prism module 24, and is transmitted to the light valve 14 through the prism module 24.

Follow the above description. The light valve 14 is disposed on the transmission path of the illumination beam IL and has an active surface 141. The active surface 141 is adapted to convert the illumination beam IL from the prism module 24 into an image beam ML. In one embodiment, the light valve 14 is, for example, a digital micro-mirror device (DMD). In another embodiment, the light valve 14 may be a liquid crystal-on-silicon (LCOS) panel. The light valve 14 reflects the image beam ML to the imaging component 16. The imaging component 16 receives and projects the image beam ML. In one embodiment, the imaging component 16 may include one or more lenses.

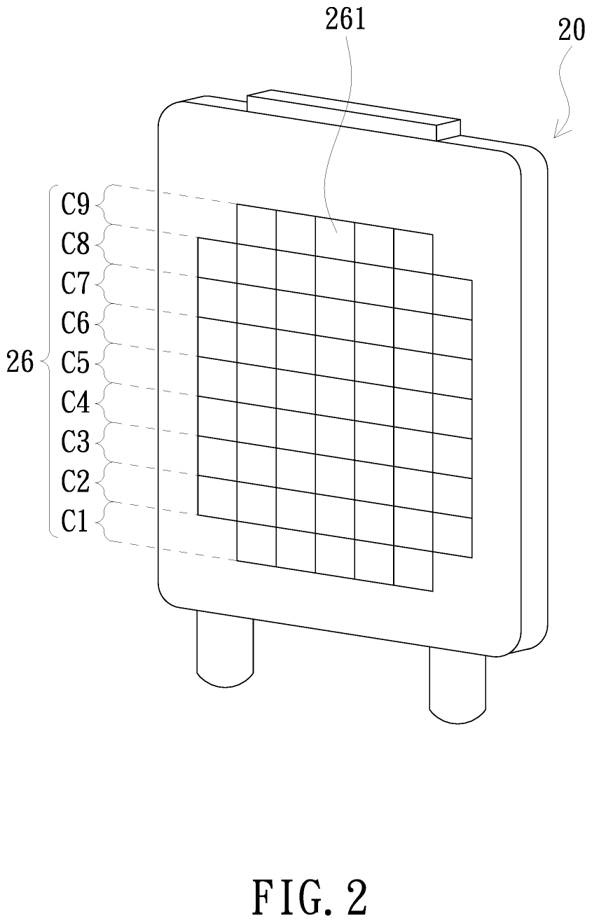

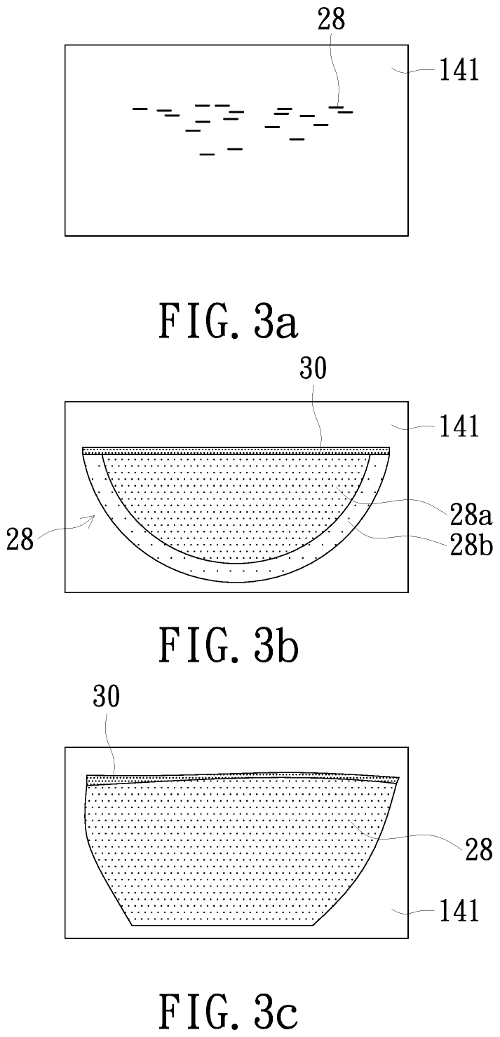

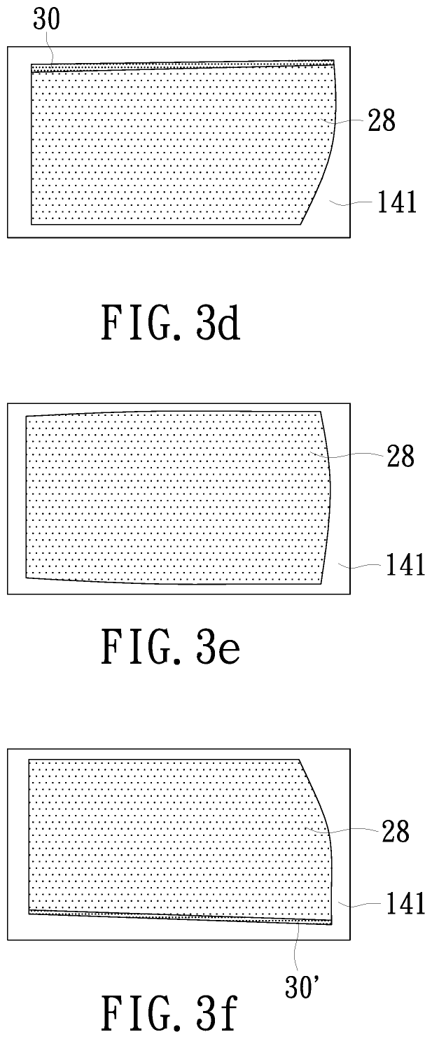

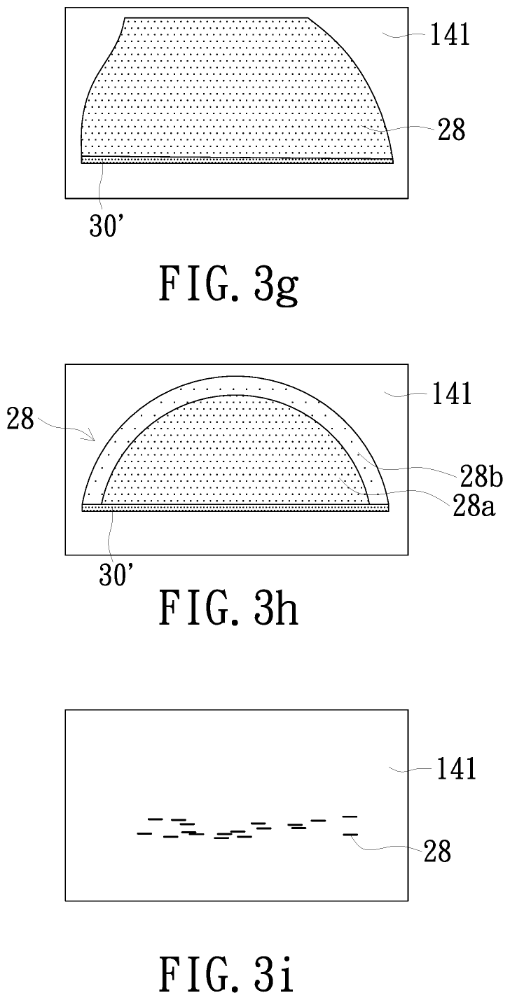

FIG. 2 is a schematic structural view of a light uniform module according to an embodiment of the invention. As shown in FIG. 2, the light uniform module 20 includes a micro-lens array 26 composed of a plurality of micro lenses 261. The micro lenses 261 are arranged in an array form having a plurality of rows and a plurality of columns of micro lenses 261. To facilitate the following explanation, the micro-lens array 26 is defined to have the first lens row C1, the second lens row C2, the third lens row C3, the fourth lens row C4, the fifth lens row C5, the sixth lens row C6, the seventh lens row C7, the eighth lens row C8 and the ninth lens row C9 in a direction from the bottom to top of the micro-lens array 26 (in the opposite direction of the gravity direction). Please refer to FIGS. 1 and 2 together. In one embodiment in which the light source module 18 is a laser diode light source module, the illumination beam IL provided by the light source module 18 is transmitted to the micro-lens array 26, and then sub-illumination beams (not labeled) are respectively outputted by the micro lenses 261 when the illumination beam IL is received by the micro-lens array 26. FIGS. 3a to 3i are respective schematic views of light spot images on the light valve 14 when the sub-illumination beams outputted by the micro lenses 261 in different rows are directly transmitted to the light valve 14 by the prism module 24. As shown in FIGS. 3a and 3i, the sub-illumination beams outputted by the first lens row C1 and the ninth lens row C9 almost have no light spot 28 distributed on the active surface 141 of the light valve 14. As shown in FIGS. 3b, 3c and 3d, the shapes of the light spots 28 on the active surface 141 of the light valve 14 respectively generated by the sub-illumination beams outputted by the second lens row C2, the third lens row C3 and the fourth lens row C4 are different. In addition to that the light spot 28 does not fill the entire active surface 141, an obvious boundary light 30 is generated at the upper edge of the light spot 28. Further, as shown in FIG. 3b, in addition to that the light spot 28 has the boundary light 30, the brightness of the light spot 28 is clearly divided into two regions 28a and 28b, wherein the brightness of region 28a is higher than the brightness of region 28b. On the other hand, as shown in FIGS. 3f, 3g and 3h, the shapes of the light spots 28 on the active surface 141 of the light valve 14 respectively generated by the sub-illumination beams outputted by the sixth lens row C6, the seventh lens row C7 and the eighth lens row C8 are different. In addition to that the light spot 28 does not fill the entire active surface 141, an obvious boundary light 30′ is generated at the bottom edge of the light spot 28. Further, as shown in FIG. 3h, in addition to that the light spot 28 has the boundary light 30′, the brightness of the light spot 28 is clearly divided into two regions 28a and 28b, wherein the brightness of region 28a is higher than the brightness of region 28b. FIG. 4a is a schematic view of a superimposed light spot on a light valve, in which the sub-illumination beams outputted by the micro-lens array 26 are directly transmitted to the light valve 14 through the prism module 24. As shown in FIG. 4a, when the light spot 28 of each micro lenses 261 (shown in FIG. 2) is superimposed, the upper and lower edges of the active surface 141 respectively generate three structured lights 32 and 32′ due to the superposition of the boundary lights 30 and 30′.

Further, in other embodiments, the projection apparatus may need to meet different size requirements, so that structured light may also be generated in the left and right edge regions of the active surface 141 of the light valve 14. That is, the superimposition of the light spots 28 generated by the micro lenses 261 located in the upper, bottom, left and/or right edge regions of the micro-lens array 26 may all generate structured lights. Further, in other embodiments in which the light source module 18 is a light emitting diode light source module, the electrodes included in the light emitting diode light source module may also generate striped structured light. In other words, the structured light may include any uneven or unexpected stray light generated on the light valve 14 due to the light source module 18 and/or the micro-lens array 26, thereby affecting the quality of the projected image.

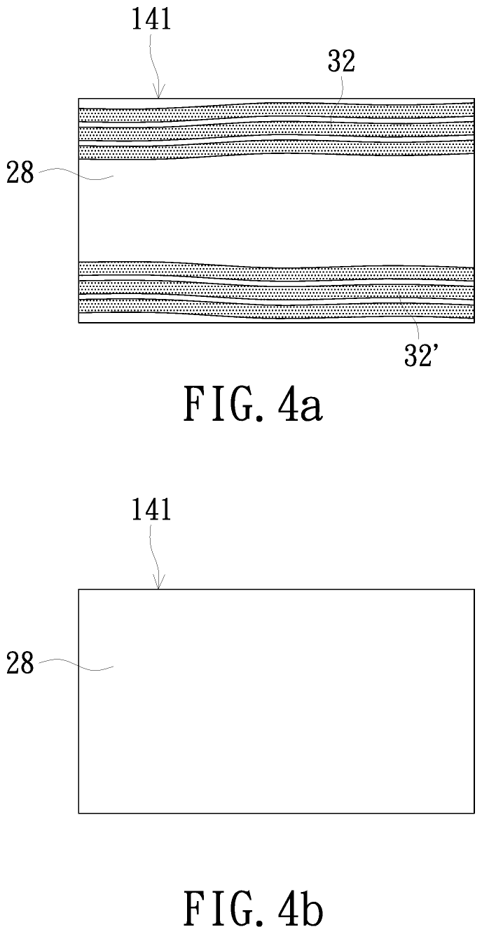

The image beam ML outputted by the light valve 14 has structural stripes (e.g., structured light 32, 32′) when the micro-lens array 26 having the micro lenses 261 with different arrangement positions is used as the light uniform module 20, resulting in poor image output quality. Therefore, a diffuser 22 is provided between the micro-lens array 26 and the prism module 24 in the embodiment of the invention. FIG. 5 is a schematic view of an arrangement in which a diffuser is disposed corresponding to a micro-lens array according to an embodiment of the invention. The diffuser 22 completely shields the micro-lens array 26. The micro lenses 261 respectively output the sub-illumination beams when the micro-lens array 26 receives the illumination beam IL. Each sub-illumination beam is first uniformized by the diffuser 22 to eliminate the superimposed structured light 32, 32′ originally generated by the micro lenses 261 located in the edge region. FIG. 4b is a schematic view of a superimposed light spot on a light valve, in which the sub-illumination beams outputted by the micro lenses 261 of the micro-lens array 26 are uniformized by the diffuser 22 according to an embodiment of the invention and transmitted to the light valve 14 through the prism module 24. As shown in FIG. 4b, the light spot 28 superimposed on the light valve 14 is evenly distributed on the entire active surface 141, so that the brightness of the structured light 32, 32′ shown in FIG. 4a is reduced, and the structured light 32, 32′ may even disappear.

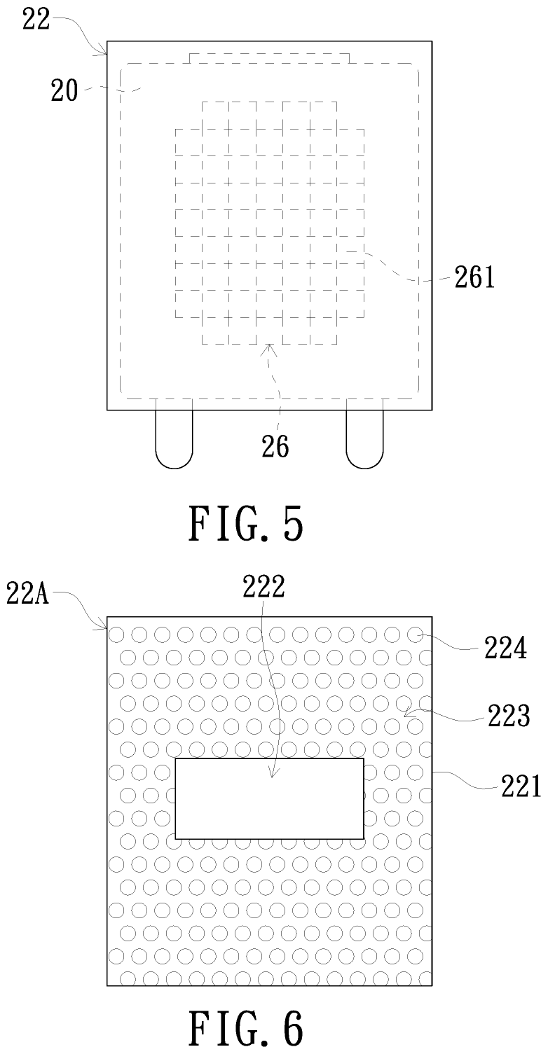

FIG. 6 is a schematic view of a diffuser according to another embodiment of the invention. In the embodiment, the diffuser 22A includes a light transmitting substrate 221 and a diffusion structure 224 formed on the light transmitting substrate 221. As shown in FIG. 6, the diffuser 22A has a light transmitting region 222 and a diffusion region 223. The diffusion region 223 has the diffusion structure, and the light transmitting region 222 does not have the diffusion structure. In one embodiment, the light transmitting region 222 may be an opening on the light transmitting substrate 221. When the diffuser 22A is disposed corresponding to the micro-lens array 26, the micro lenses 261 in the middle rows (e.g., the fourth lens row C4, the fifth lens row C5, and the sixth lens row C6) are exposed through the light transmitting region 222 (i.e., the opening) of the diffuser 22A.

Follow the above description. Among the sub-illumination beams outputted by the micro lenses 261, a part of the sub-illumination beams (e.g., sub-illumination beams outputted by the micro lenses 261 in the fourth lens row C4, the fifth lens row C5 and the sixth lens row C6 in FIG. 2) does not have the aforementioned problem of the boundary light 30; therefore, the sub-illumination beams outputted by the micro lenses 261 in the fourth lens row C4, the fifth lens row C5 and the sixth lens row C6 can be designed to pass through the diffuser 22A to the prism module 24 through the light transmitting region 222, and the other part of the sub-illumination beams can be designed to pass through the diffuser 22A to the prism module 24 through the diffusion region 223. In this way, the sub-illumination beams outputted by the micro lenses 261 located in the middle rows can be directly transmitted to the prism module 24 through the light transmitting region 222, thereby achieving the effect of improving geometric efficiency. Those skilled in the art can know the definition of geometric efficiency, and no redundant detail is to be given herein. In the embodiment, the configuration in which the diffuser 22A with an opening as the light transmitting region 222 is disposed between the micro-lens array 26 and the prism module 24 can improve the geometric efficiency by about 10%, compared to the configuration in which the diffuser 22 does not have the light transmitting region 222 and completely shields the micro-lens array 26. In addition, the light transmitting region of the diffuser 22A is not limited to correspond to the middle rows in the micro-lens array 26, and the light transmitting region can be adjusted correspondingly according to the position where the structured light is not generated, for example, corresponding to the middle columns or central region of the intersection of the middle rows and the middle columns. In other words, the structured light is generated when the diffuser 22A is not used, and then the position where the structured light is generated is known, and then the diffuser 22A is provided to eliminate the structured light. In addition, the light transmitting region may be provided correspondingly at a position where the structured light is not generated.

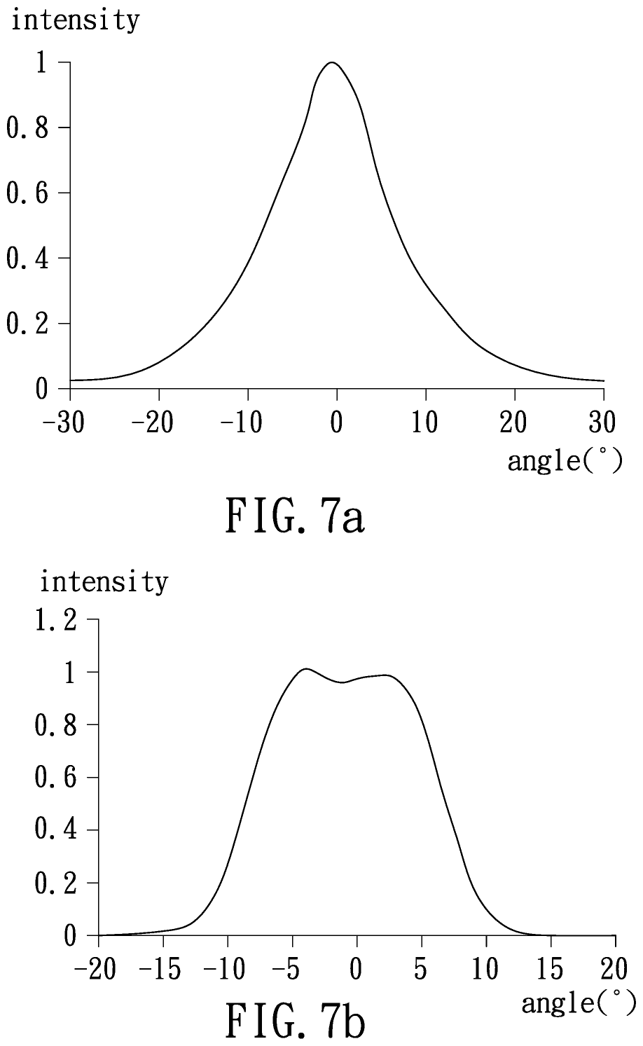

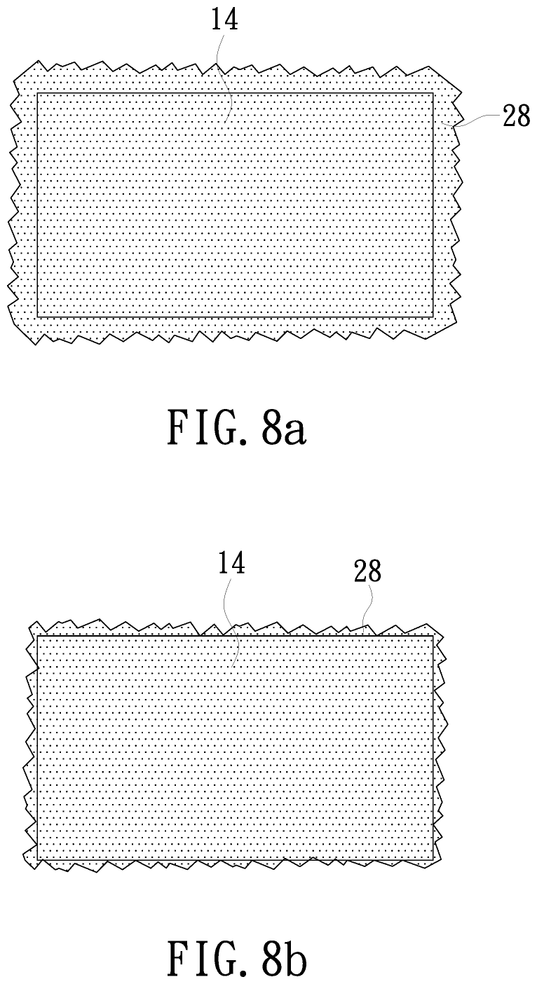

In order to improve the geometric efficiency, a top-hat type diffuser may be used as the diffuser 22 in one embodiment. Compared with a general Gaussian type diffuser, the top-hat type diffuser can more effectively converge the light spot on the light valve, so that light is converged more uniform. FIGS. 7a and 7b are schematic views of the diffusion angle and light intensity of a Gaussian type diffuser and a top-hat type diffuser, respectively. FIGS. 8a and 8b are schematic views of the light spot on the light valve formed by a Gaussian type diffuser and a top-hat type diffuser, respectively, wherein it is shown that the light spot outputted by the Gaussian type diffuser is large and scattered. As shown in FIG. 8a, in addition to being distributed on the active surface of the light valve 14, the light spot 28 is also scattered around the light valve 14, so that the geometrical efficiency decreases. As shown in FIGS. 7a and 7b, the Gaussian type diffuser and the top-hat type diffuser both diffuse at 15 degrees at the same FWHM diffusion angle, but the top-hat type diffuser has more convergent light spot 28. As shown in FIG. 8b, the light spot 28 converges in the region of the light valve 14 but still has the effect of eliminating structured light, thereby effectively improving the geometric efficiency. Compared with the configuration in which a Gaussian type diffuser is disposed between the micro-lens array 26 and the prism module 24, the configuration in which a top-hat type diffuser is disposed between the micro-lens array 26 and the prism module 24 can improve geometric efficiency by about 8%.

In the embodiment shown in FIG. 1, the prism module 24 includes a first prism 241, a second prism 242 and a third prism 243. The first prism 241 has a curved surface, and the curved surface has a reflective layer R. The reflective layer R is used to reflect the illumination beam IL from the diffuser 22 to the light valve 14. In one embodiment, there is a slight air gap (not shown) between any two adjacent prisms of the first prism 241, the second prism 242 and the third prism 243. For example, the first gap is formed between the first prism 241 and the second prism 242, and the second gap is formed between the second prism 242 and the third prism 243. The illumination beam IL from the diffuser 22/22A is transmitted to the active surface 141 of the light valve 14 sequentially through the first prism 241, the reflective layer R of the curved surface, the first gap, the second prism 242, the second gap and the third prism 243. The light valve 14 then converts the illumination beam IL into the image beam ML and reflects the image beam ML to the third prism 243. The third prism 243 reflects the image beam ML to the imaging component 16 in a total internal reflection (TIR) manner.

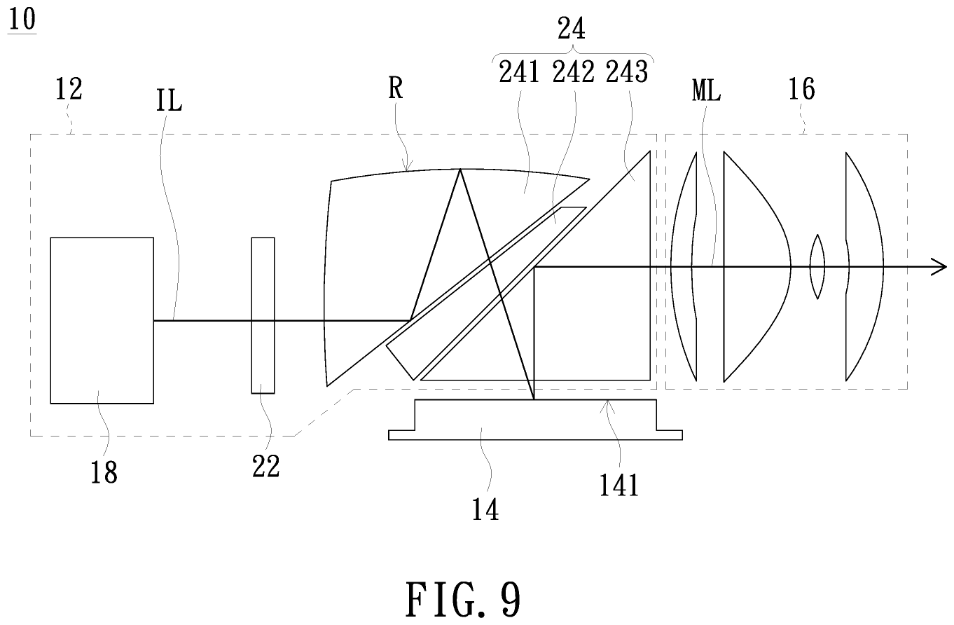

FIG. 9 is a schematic view of a projection apparatus according to another embodiment of the invention. As shown in FIG. 9, the projection apparatus 10 includes an illumination component 12, a light valve 14 and an imaging component 16. The embodiment of FIG. 9 is different from the embodiment of FIG. 1 in that the light source module 18 is a light emitting diode light source module and the illumination component 12 does not include the light uniform module 20. The illumination component 12 is used to provide an illumination beam IL to the light valve 14. The illumination component 12 includes a light source module 18, a diffuser 22 and a prism module 24. The light source module 18 provides an illumination beam IL. The illumination beam IL is transmitted to the light valve 14 through the diffuser 22 and the prism module 24. In the embodiment, the light source module 18 has a light emitting side, and the diffuser 22 is disposed between the light source module 18 and the prism module 24. The illumination beam IL passes through the diffuser 22 to the prism module 24 and is transmitted to the light valve 14 through the prism module 24. In the embodiment in which the light source module 18 is a light emitting diode light source module, the electrodes included in the light emitting diode light source module may also generate the striped structured light, and the uneven or unexpected stray light may be generated on the active surface 141 of the light valve 14, thereby affecting the quality of the projected image.

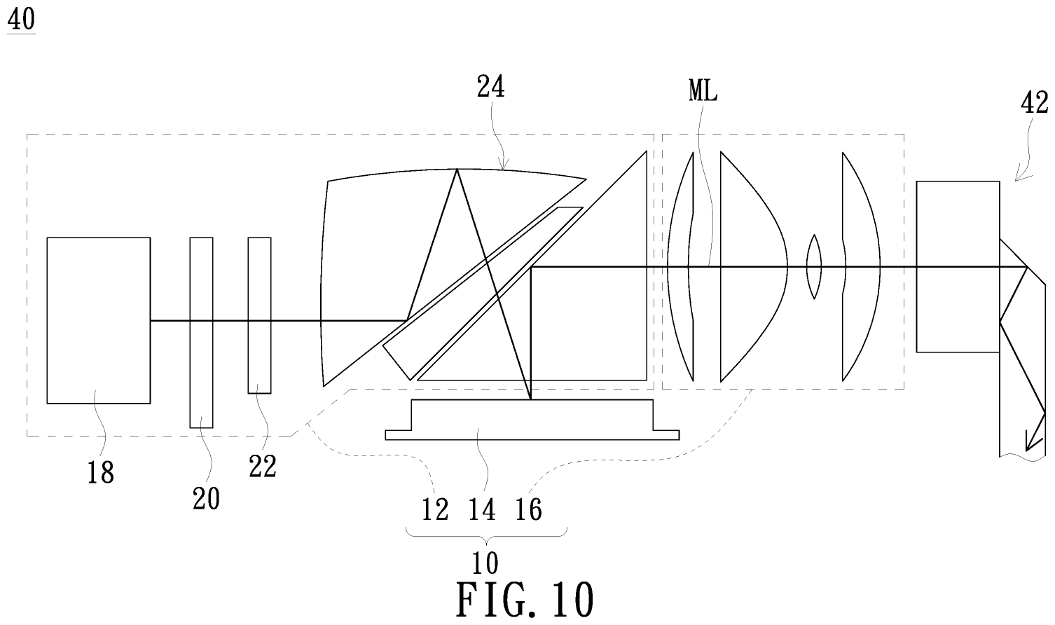

FIG. 10 is a schematic view of a wearable display device according to an embodiment of the invention. As shown in FIG. 10, the wearable display device 40 includes a projection apparatus 10 and a waveguide element 42. The waveguide element 42 is, for example, a high light transmission element made of glass or plastic and used to transmit image beams. The projection apparatus 10 includes an illumination component 12, a light valve 14 and an imaging component 16. The waveguide element 42 is disposed on one side of the imaging component 16; specifically, the imaging component 16 is located between the light valve 14 and the waveguide element 42. The illumination component 12 includes a light source module 18, a light uniform module 20, a diffuser 22 and a prism module 24. The light source module 18 provides the illumination beam IL. The illumination beam IL is transmitted to the light valve 14 through the light uniform module 20, the diffuser 22 and the prism module 24. The light valve 14 converts the illumination beam IL into an image beam ML. The imaging component 16 receives and projects the image beam ML to the waveguide element 42. The waveguide element 42 guides the image beam ML so that the image beam ML is projected to a projection target, such as human eyes.

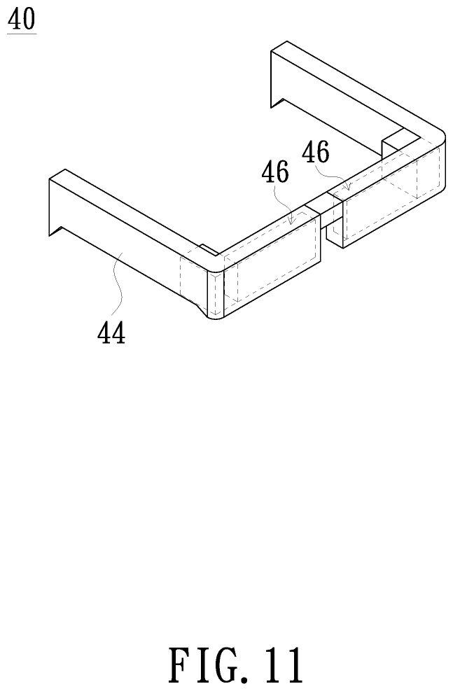

FIG. 11 is a schematic application view of a wearable display device according to an embodiment of the invention. As shown in FIG. 11, the wearable display device 40 further includes a wearing frame 44. In one embodiment, the wearing frame 44 can be worn on the user's head. The projection apparatus 10 is disposed in the wearing frame 44. An imaging component 46 is disposed on the wearing frame 44. The waveguide element 42 is, for example, disposed in the imaging component 46. The quantity of the imaging components 46 is, for example, two, and the two imaging components 46 are respectively located corresponding to the eyes of the user when the user wears the wearing frame 44, so that the eyes of the user can see the images provided by the two imaging components 46 respectively. The invention does not limit the specific structure of the wearing frame 44, and the wearable display device 40 can be applied to augmented reality (AR) devices or virtual reality (VR) devices.

In summary, in the projection apparatus of the embodiment of the invention, the configuration in which the diffuser is disposed between the light uniform module and the prism module or the diffuser is disposed between the light source module and the prism module can eliminate the structured light caused by volume limitation of the projection apparatus, that is, reduce the distribution of uneven light. Further, the use of a diffuser with an opening or a top-hat type diffuser can effectively improve the geometric efficiency caused by a general diffuser.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first prism and the second prism are only used for distinguishing various elements and do not limit the number of the elements.

What is claimed is:

1. A projection apparatus, comprising an illumination component, a light valve and an imaging component, wherein:
the illumination component comprises a light source module, a diffuser and a prism module, wherein:
the light source module is configured to provide an illumination beam, and the light source module has a light emitting side,
the diffuser is disposed between the light source module and the prism module, and the illumination beam passes through the diffuser to the prism module;
the light valve has an active surface for converting the illumination beam into an image beam, and the illumination beam passing through the diffuser is transmitted to the light valve through the prism module; and
the imaging component receives and projects the image beam.

2. The projection apparatus according to claim 1, wherein the illumination component further comprises a light uniform module, the light uniform module is disposed on the light emitting side, the diffuser is disposed between the light uniform module and the prism modules, and the illumination beam passes through the light uniform module and the diffuser to the prism module.

3. The projection apparatus according to claim 2, wherein the light uniform module comprises a micro-lens array.

4. The projection apparatus according to claim 1, wherein the diffuser is a Gaussian type diffuser or a top-hat type diffuser.

5. The projection apparatus according to claim 2, wherein the diffuser has a light transmitting region and a diffusion region, the diffusion region has a diffusion structure, and the light transmitting region does not have the diffusion structure.

6. The projection apparatus according to claim 5, wherein the diffuser comprises a light transmitting substrate and the diffusion structure formed on the light transmitting substrate, and the light transmitting region is an opening on the light transmitting substrate or a region of the light transmitting substrate where the diffusion structure is not formed.

7. The projection apparatus according to claim 5, wherein the light uniform module comprises a micro-lens array, the micro-lens array comprises a plurality of micro lenses, the plurality of micro lenses respectively output sub-illumination beams after the micro-lens array receives the illumination beam, a part of the sub-illumination beams passes through the diffuser through the light transmitting region, and the other part of the sub-illumination beams passes through the diffuser through the diffusion region.

8. The projection apparatus according to claim 7, wherein the micro lenses are arranged in an array form having a plurality of rows and columns, and the sub-illumination beams outputted by the micro lenses located in the middle rows or in the middle columns pass through the diffuser through the light transmitting region.

9. The projection apparatus according to claim 1, wherein the prism module comprises a first prism, a second prism and a third prism, the second prism is located between the first prism and the third prism, and the illumination beam from the diffuser is transmitted to the light valve through the first prism, the second prism and the third prism.

10. The projection apparatus according to claim 1, wherein the prism module comprises at least one first prism, the at least one first prism has a curved surface, and the curved surface has a reflective layer for reflecting the illumination beam from the diffuser.

11. The projection apparatus according to claim 1, wherein the light source module comprises a laser diode light source module or a light emitting diode light source module.

12. A wearable display device, comprising a projection apparatus and a waveguide element, wherein:
the projection apparatus comprises an illumination component, a light valve and an imaging component, wherein:
the illumination component comprises a light source module, a diffuser and a prism module, the light source module provides an illumination beam, the light source module has a light emitting side, the diffuser is disposed between the light source module and the prism module, and the illumination beam passes through the diffuser to the prism module;
the light valve has an active surface for converting the illumination beam into an image beam, and the illumination beam passing through the diffuser is transmitted to the light valve through the prism module; and
the imaging component receives and projects the image beam; and
the waveguide element guides the image beam and projects the image beam to a projection target.

13. The wearable display device according to claim 12, wherein the illumination component further comprises a light uniform module, the light uniform module is disposed on the light emitting side, the diffuser is disposed between the light uniform module and the prism modules, and the illumination beam passes through the light uniform module and the diffuser to the prism module.

14. The wearable display device according to claim 13, wherein the light uniform module comprises a micro-lens array.

15. The wearable display device according to claim 12, wherein the diffuser is a Gaussian type diffuser or a top-hat type diffuser.

16. The wearable display device according to claim 12, wherein the diffuser has a light transmitting region and a diffusion region, the diffusion region has a diffusion structure, and the light transmitting region does not have the diffusion structure.

17. The wearable display device according to claim 12, further comprising a wearing frame, and the projection apparatus and the waveguide element are disposed in the wearing frame.
